(19) United States
(12) Patent Application Publication
(10) Pub. No.: US 2017/0067195 A1
(43) Pub. Date: Mar. 9, 2017

(54) Drive Motor Attachment Assembly for a Sewing Machine

(71) Applicant: Frankl & Kirchner GmbH & Co KG Fabrik für Elektromotoren u. elektrische Apparate, Schwetzingen (DE)

(72) Inventor: Hans Georg Kolb, Plankstadt (DE)

(21) Appl. No.: 15/261,092

(22) Filed: Sep. 9, 2016

(30) Foreign Application Priority Data
Sep. 9, 2015 (DE) 10 2015 217 216.3

(51) Int. Cl. D05B 69/12; F16H 7/02

(52) U.S. Cl. CPC D05B 69/12; F16H 7/023

(57) ABSTRACT

A modular drive motor attachment for a sewing machine has a drive motor attachment. This is designed to attach to an attachment region, arranged at the place where a transmission shaft of the sewing machine extends out of a housing of the sewing machine. The drive motor is designed to attach in such a manner that a motor shaft of the drive motor attachment is not aligned with the transmission shaft. A flexible transmission member serves to transfer force from the motor shaft of the drive motor attachment to the transmission shaft of the sewing machine. This results in a flexibly attachable module.

### CROSS-REFERENCE TO RELATED APPLICATIONS

This application claims the priority of German Patent Application Serial No. DE 10 2015 217 216.3 filed on Sep. 9, 2015, pursuant to 35 U.S.C. 119(a)-(d), the content of which is incorporated herein by reference in its entirety as if fully set forth herein.

### FIELD OF THE INVENTION

The invention concerns a drive motor attachment assembly for a sewing machine. Furthermore, the invention concerns a sewing machine with module of this type.

### BACKGROUND OF THE INVENTION

Assemblies of this type are known from, for example, CN 202 817 967 U, CN 201 860 197 U and CN 102 075 037 B. An electrically-driven sewing machine is known from DE 1 690 614 U. EP 1 137 835 B1 shows a sewing machine with an electric motor having a fan wheel and a rotational speed sensor. DE 29 36 697 C2 shows another version of a sewing machine.

### SUMMARY OF THE INVENTION

A task of the present invention is to develop a drive motor attachment assembly of the type mentioned at the beginning and a sewing machine equipped with it such that it can be fitted with greater flexibility, in other words with greater degrees of freedom than those provided by prior art concerning attachments.

According to the invention, this task is resolved by a drive motor attachment assembly for a sewing machine, with a drive motor attachment designed to attach to an attachment region, arranged at the place where a transmission shaft of the sewing machine extends out of a housing of the sewing machine, designed to attach in such a manner that a motor shaft of the drive motor attachment is not aligned with the transmission shaft, with a flexible transmission member to transfer force from the motor shaft of the drive motor attachment to the transmission shaft of the sewing machine and by a sewing machine with a drive motor attachment assembly according to the invention.

According to the invention, it was recognised that significant advantages are offered by not attaching the drive motor directly to the transmission shaft of the sewing machine, in other words by not aligning the motor shaft directly with the transmission shaft. The flexible transmission member enables the drive motor attachment to be positioned more freely relative to the transmission shaft. By doing so, it is easier to meet installation space requirements. Furthermore, by using the flexible transmission member, aligning the motor shaft with the transmission shaft does not require extreme accuracy. Gap tolerances between the motor shaft and the transmission shaft and/or angular tolerances with regard to the orientation of the two axes of the shafts to one another can be tolerated. In particular, lateral forces can be accommodated by the flexible transmission member without interfering with the operation of the modular drive motor attachment. As a general rule, the motor shaft is offset or displaced only slightly from the transmission shaft, such as by no more than 15 cm, 10 cm or by an even smaller amount. The offset or displacement of the shafts can be less that 90 mm, 80 mm, 70 mm, 60 mm, 50 mm, or 40 mm and can even be 35 mm for example. This enables attachment of the drive motor attachment assembly to be compact. The assembly maybe embodied in modular fashion.

A toothed belt has proved to be a robust, low-wear transmission member.

An encoder unit to detect a circumferential position of the motor shaft provides a reliable means of detecting the position of the motor shaft. If the transmission member can provide a transmission ratio of 1:1 between the motor shaft and the transmission shaft, the detection of the position of the motor shaft simultaneously results in giving the position of the transmission shaft which can be used as control data for the sewing machine.

Gearing alternatives designed with a transmission ratio other than 1:1 between the motor shaft and the transmission shaft, as a gearing-up transmission or as a gearing-down transmission have proved practicable based on the requirements of the sewing machine. The transmission gearing alternative designed as a gearing-up transmission provides a high rotational speed of the transmission shaft. The transmission gearing alternative designed as a gearing-down transmission provides a high torque in the transmission shaft.

A housing subdivision having a multiplicity of sections with a transmission member housing section and a drive motor housing section attaching to it enables the transmission member to be placed at least partly below the level of a sewing machine table, for example, while the drive motor is arranged above the level of this table. For example, a hand wheel can be made freely accessible for an operator in spite of the fact that the sewing machine transmission shaft would run below the level of the table. The transmission member housing section can be subdivided into an adjustable housing section, which is adapted to the particular type of sewing machine, and into a bearing plate housing section to actually accommodate the transmission member. If the transmission member is designed as a toothed belt, the bearing plate housing section can have guide components to define the positioning of the toothed belt when the module is being assembled. These guide components can be designed as guide webs. The guide webs can be formed as part of the bearing plate housing section. The bearing plate housing section can be displaced laterally and infinitely variably along the pitch line between the motor shaft of the drive motor attachment and the transmission shaft of the sewing machine and can be secured in a defined movement position on the transmission member housing section. In addition, elongated holes can be formed in the bearing plate housing section. The bearing housing section can have a recess to accommodate an axial section of a transmission shaft gear wheel by means of which the axial installation depth of the module is reduced. The bearing plate housing section can be always be made with the same construction independently of the design of the sewing machine.

A mounting point of the the transmission member housing section for a transmission shaft position sensor provides a compact way of fitting a position sensor to record the circumferential position of the transmission shaft. A position sensor of this type can be a component part of the module. The position sensor is able to detect a position of the transmission shaft even if gearing with a transmission ratio other than 1:1 is arranged between the motor shaft and the transmission shaft.

A position sensor designed as a Hall sensor has proved to be a suitable position sensor.

An arrangement of the drive motor attachment axially between the motor shaft and the transmission shaft provides a flexible construction. In particular, it is possible to achieve a small gap between the motor shaft of the drive motor attachment and the transmission shaft.

The advantages of a sewing machine with a drive motor attachment assembly according to the invention correspond to those which have been explained above already in connection with the modular drive motor attachment according to the invention.

Examples of embodiments of the invention are explained below in more detail with the aid of the drawings.

### BRIEF DESCRIPTION OF THE DRAWINGS

FIG. 1 a modular drive motor attachment for a diagrammatically illustrated sewing machine;

FIG. 2 the modular drive motor attachment in FIG. 1 with the transmission member housing section omitted;

FIG. 3 an illustration similar to FIG. 1 of another embodiment of a modular drive motor attachment with a transmission member housing section sunk partly below the table level of the sewing machine;

FIG. 4 a view similar to FIG. 1 of another embodiment of a modular drive motor attachment in which a transmission member housing section is omitted;

FIG. 5 the module from FIG. 4, with a view looking away from a bearing plate housing section of the module; and

FIG. 6 the module according to FIG. 1 with the drive motor housing section omitted.

### DESCRIPTION OF THE PREFERRED EMBODIMENTS

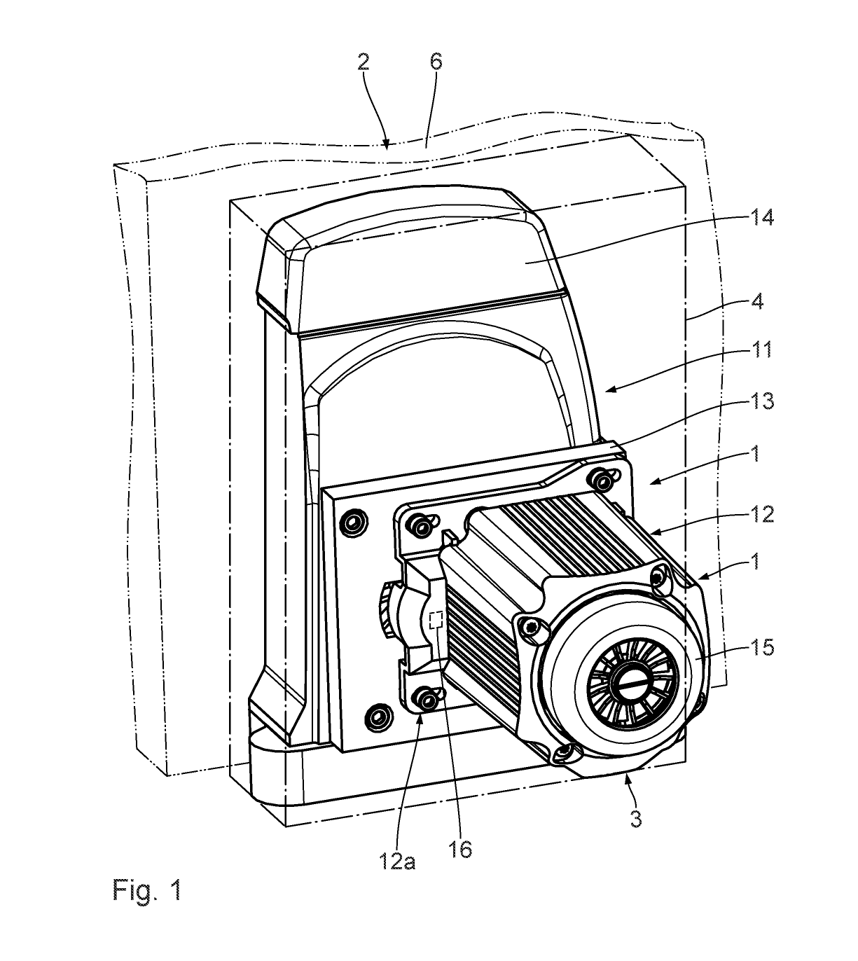

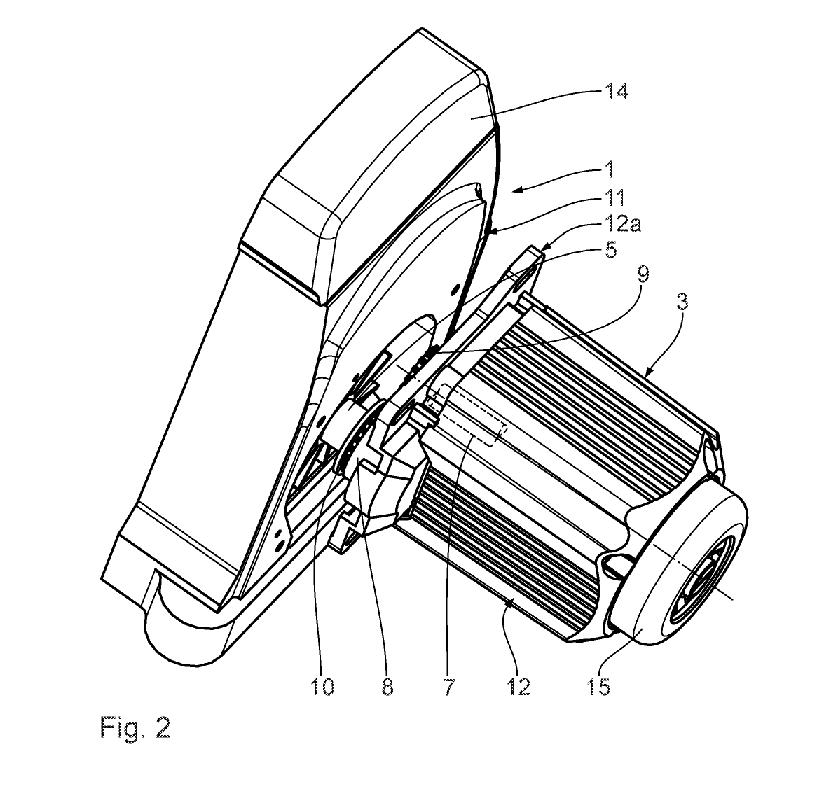

A first embodiment of a modular drive motor attachment 1 for a sewing machine 2 just illustrated diagrammatically is explained below with the aid of FIGS. 1 and 2. The sewing machine 2 in question is an Overlock sewing machine.

The modular drive motor attachment 1 serves to attach a drive motor 3 (cf. FIG. 2) on the sewing machine 2 with factory-predetermined attachment dimensions. The module is designed to attach to an attachment region 4 of the sewing machine 2. The spatial requirements for the attachment region 4 are indicated by a cuboid figure in FIG. 1. This attachment region 4 has to be left clear in the preparation stage of the sewing machine 2 in the factory.

The attachment region 4 is arranged at a place where a transmission shaft 5 (cf. FIG. 2) of the sewing machine 2 extends out of a housing 6 of the sewing machine 2.

The drive motor attachment 3 is designed to attach to the sewing machine 2 such that a motor shaft 7 of the drive motor attachment 3, whose motion is indicated with dotted lines in FIG. 2, does not align with the transmission shaft 5 of the sewing machine 2.

The transmission shaft 5 in question is a lower shaft of the sewing machine 2 which runs in the region of a base plate of the sewing machine housing 6.

A flexible transmission member, designed as toothed belt 8 (cf. FIG. 2) serves to transmit force from the motor shaft 7 of the drive motor attachment 3 to the transmission shaft 5 of the sewing machine 2.

The offset gap between the parallel-running shaft axes of the transmission shaft 5 and the motor shaft 7 is small in comparison with the typical dimensions of the modular drive motor attachment 1 and, as a general rule, is less than 15 cm.

The toothed belt 8 transmits the driving force from a drive gear wheel 9 connected to rotate with the motor shaft 7 to a transmission gear wheel 10 connected to rotate with the transmission shaft 5.

The two gear wheels 9 and 10 have the same number of teeth so that the transmission ratio is exactly one. The drive motor 3 is fitted with an encoder unit to detect the circumferential position of the motor shaft 7. Due to the 1:1 transmission ratio, the circumferential position of the transmission shaft 5 is defined also by the circumferential position of the motor shaft 7 and therefore the position of components driven by the latter.

A housing 11 of the modular drive motor attachment 1 is subdivided into several sections separable from each other. These include a drive motor housing section 12 to which a bearing plate housing section 12a and a transmission member housing section 13 are joined. Compared with FIG. 1, these three housing sections 12, 12a, 13 are removed in FIG. 2. A housing section 14 on the sewing machine side is connected to the transmission member housing section 13.

The housing sections 12, 12a and 13 are made of plastic. Alternatively, the bearing plate housing section 12a in particular can be made of aluminium.

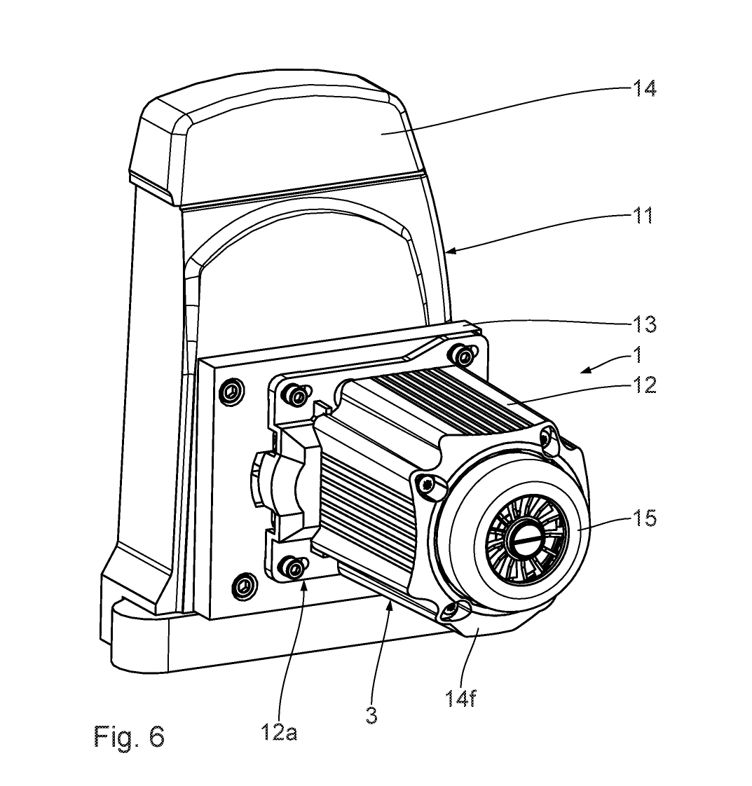

The drive motor housing section 12 serves, on the one hand, to cover the drive motor 3 and, on the other hand, acts as a heat shield. The drive motor housing section 12 is omitted in FIG. 6.

The bearing plate housing section 12a serves to accommodate the drive gear wheel 9, the transmission gear wheel 10 and the toothed belt 8. A round recess 14a in the bearing plate housing section 12a serves to accommodate an axially-directed section of the transmission gear wheel 10 and enables the bearing plate housing section 12a to be set back axially as close as possible to the sewing machine 2. The bearing plate housing section 12a has a multiplicity of guide webs 14b. The guide webs 14b are formed integrally on a base body of the bearing plate housing section 12a.

On their front faces, the guide webs 14b each have an axially projecting pilot guide 14c. The side facing guide surfaces 14d of the pilot guides 14c provide a rounded outer guide contour for the toothed belt 8. During assembly of the modular drive motor attachment 1, the toothed belt 8 can be inserted between these guide faces 14d, thereby at least assuming approximately the shape which it will also have in its assembled form when transmitting a force between the gear wheels 9, 10. This makes it easier for the teeth of the gear wheels 9, 10 to engage in the complementary teeth of the toothed belt 8 during the subsequent assembly of module 1.

The bearing plate housing section 12a can be moved laterally and infinitely variably along the line of the pitch between the shafts 5, 7 relative to the transmission member housing section 13 to tension the toothed belt 8. A predetermined end position of the bearing plate housing section 12a relative to the transmission member housing section 13 is fixed by screws which are passed through elongated holes 14e in the bearing plate housing section 12a.

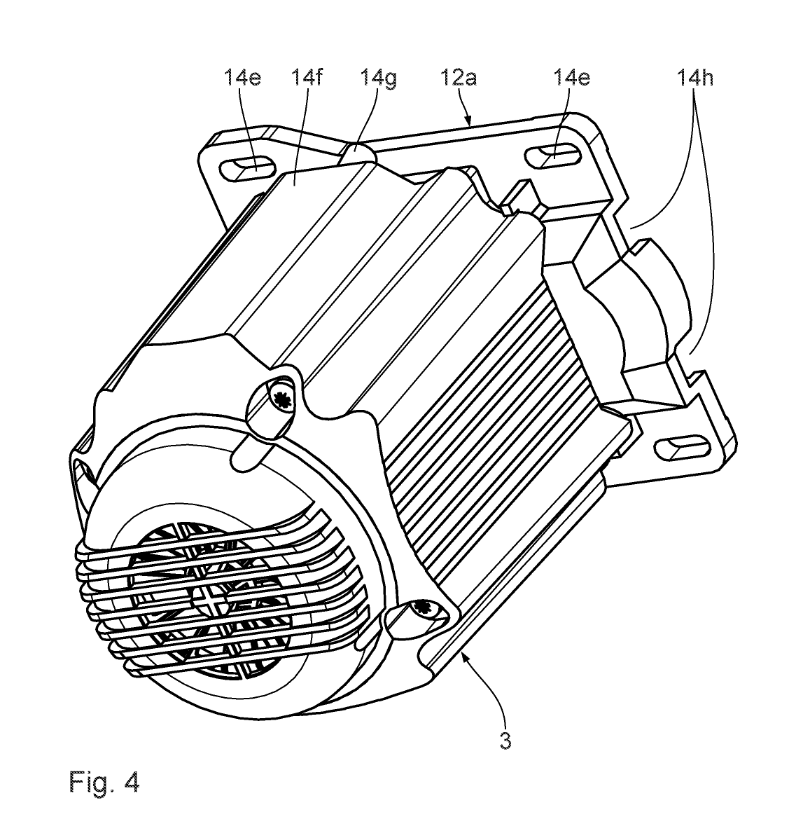

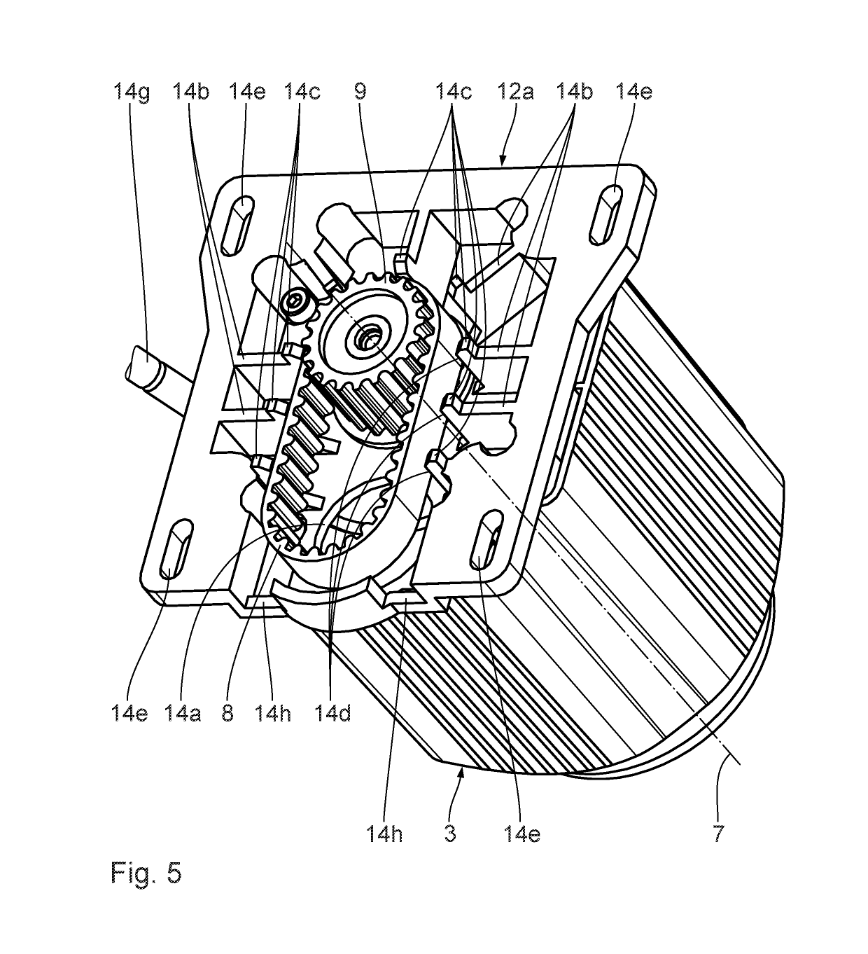

In the case of the module embodiments illustrated in FIGS. 4 and 6, each of the drawings displays a cable cover housing section 14f which is attached laterally on the drive motor 3. This cable cover housing section 14f covers a section of a cable loom 14g illustrated diagrammatically in FIG. 5. The cable loom 14g contains signal cables for the encoder unit as well as signal cables for motor control.

In an embodiment (not shown) of the force transmission from the motor shaft 7 to the transmission shaft 5, gearing is used between the motor shaft 7 and the transmission shaft 5 with a transmission ratio other than 1:1. In this case, the gearing can be designed optionally as a gearing-up or a gearing-down transmission. With a gearing-up transmission, the rotational speed of the transmission shaft 5 is higher for a given rotational speed of the motor shaft 7. With a gearing-down transmission, a given rotational speed of the motor shaft 7 produces a high torque in the transmission shaft 5.

A free end of the motor shaft 7 projecting axially beyond the drive motor housing section 12 is connected to a hand wheel 15 to rotate with it.

Especially in the case where gearing is used with a transmission ratio other than 1:1, the modular drive motor attachment 11 can have a mounting for a transmission shaft position sensor 16, in particular for a Hall sensor. This position sensor 16 is designed to record a circumferential position of the transmission shaft 5. The position sensor 16 serves to synchronise the motor shaft 7 with the transmission shaft 5 electronically. The position sensor 16 can be designed as a magnetic encoder with, in particular, a disc of a magnetic material and alternating north and south pole elements serving as incremental markings.

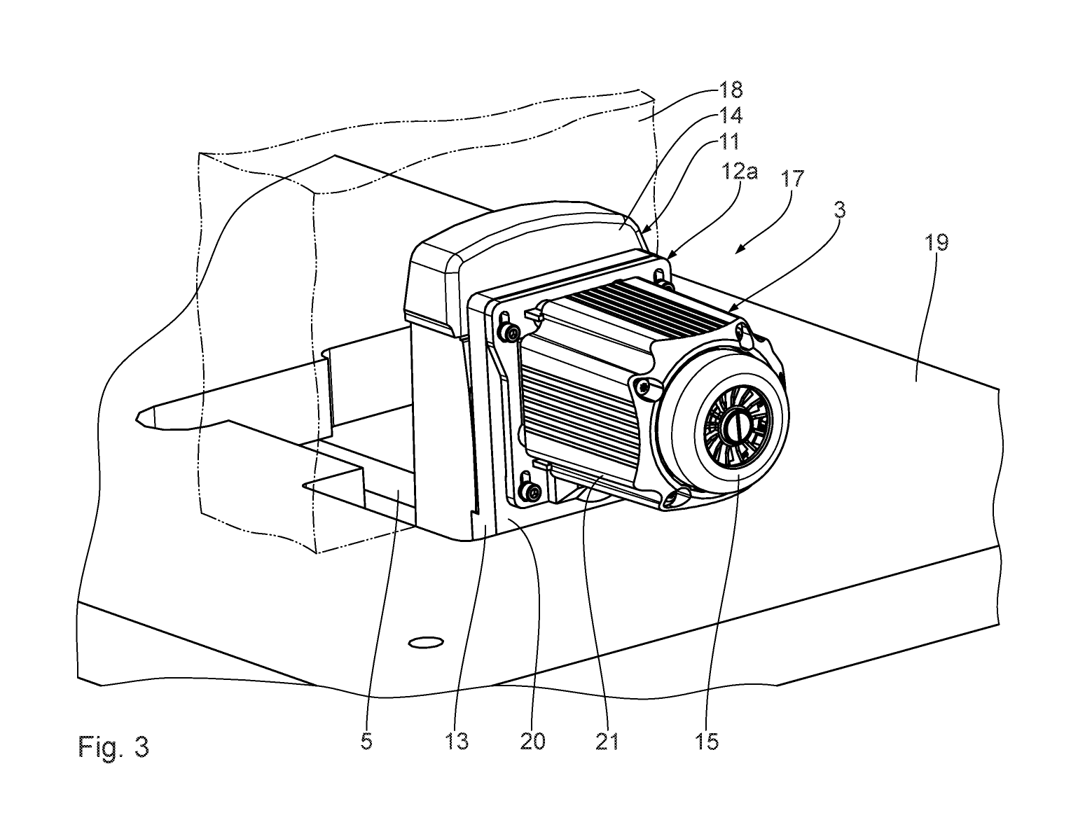

Another embodiment of a modular drive motor attachment 17 is explained below with the aid of FIG. 3. Components corresponding to those described above already in connection with FIGS. 1 and 2 have the same reference symbols and are not discussed again in detail.

A sewing machine 18, for which the modular drive motor attachment 17 is designed, has a transmission shaft 5 which is arranged below the level of a table plate or base plate 19 of the sewing machine 18, which can equate to the level of a needle plate.

With the modular drive motor attachment 17, the motor shaft 7 is arranged in relation to the transmission shaft 5 such that the motor shaft 7 is offset upwards relative to the transmission shaft 5 and runs above the level of the table plate 19. An adjustable transmission member housing section 20 of the modular drive motor attachment 17 is arranged partly in the table plate 19, so that a region of the transmission housing section 20 is arranged below the level of the table plate 19 and another region of the transmission housing section 20 is above the level of the table plate 19. A drive motor housing section 21 of the modular drive motor attachment 17 is arranged above the level of the table plate 19, so that the hand wheel 15 is freely accessible for an operator in spite of the fact that the transmission shaft 5 would be located under the level of the table.

For the different embodiments described above of the modular drive motor attachments, the design of the bearing plate housing section 12a is identical in each case. The transmission member housing section 13 or 20 services to adapt the particular module to the sewing machine 2 or to the housing section 14 on the sewing machine side. This housing section is designed, therefore, depending on the type of sewing machine. If it is necessary for the toothed belt 8 to span over a larger distance between shafts, cut-outs 14h are made in the bearing plate housing section 12a, through which the toothed belt 8 can be drawn laterally outwards out of the bearing plate housing section 12a.

The circumferential position of the cable cover housing section 14f on the drive motor 3 is determined in each case by the structural requirements for the modular drive motor attachment. In the case of the embodiment in FIG. 4, the cable cover housing section 14f is arranged horizontally adjacent to the drive motor 3 on the right hand side in FIG. 4. With the embodiment in FIG. 6, the cable cover housing section 14f is arranged underneath the drive motor 3.

1. A drive motor attachment assembly for a sewing machine, comprising:
a drive motor attachment having a motor shaft, the drive motor attachment:
configured to attach to an attachment region, arranged where a transmission shaft of the sewing machine extends out of a housing of the sewing machine, and
configured to attach to the attachment region with the motor shaft of the drive motor attachment is not aligned with the transmission shaft; and
a flexible transmission member to transfer force from the motor shaft of the drive motor attachment to the transmission shaft of the sewing machine.

2. The assembly according to claim 1, wherein the transmission member is comprised of a toothed belt.

3. The assembly according to claim 1, further comprising an encoder unit to detect a circumferential position of the motor shaft.

4. The assembly according to claim 1, further comprising gearing with a transmission ratio other than 1:1 that is disposed between the motor shaft and the transmission shaft.

5. The assembly according to claim 4, wherein the gearing is part of a gearing-up transmission.

6. The assembly according to claim 4, wherein the gearing is part of a gearing-down transmission.

7. The assembly according to claim 1, further comprising a housing having a multiplicity of sections with a transmission member housing section and a drive motor housing section.

8. The assembly according to claim 7, wherein the transmission member housing section has a mounting for a transmission shaft position sensor.

9. The assembly according to claim 8, wherein the position sensor is comprised of a Hall sensor.

10. The assembly according to claim 1, wherein the flexible transmission member is arranged axially between the motor shaft and the transmission shaft.

11. A sewing machine with a drive motor attachment assembly according to claim 1.

12. The assembly according to claim 1, wherein the drive motor attachment comprises a drive motor from which the motor shaft extends outwardly.

13. A drive motor attachment assembly for a sewing machine having an attachment region, comprising:
a drive motor attachment having a drive motor with a motor shaft, the drive motor attachment mounted to the attachment region of the sewing machine and offsetting the motor shaft from a transmission shaft of the sewing machine so that the motor shaft is not aligned with the transmission shaft; and
a flexible transmission member coupling the motor shaft to the transmission shaft enabling motive force to be transferred from the motor shaft to the transmission shaft to power the sewing machine.

14. The assembly according to claim 13, wherein the flexible transmission member comprises a belt.

15. The assembly according to claim 14, wherein the motor shaft carries a drive gear wheel, the transmission shaft carries a transmission gear wheel, and the flexible transmission member comprises a toothed belt coupling the drive gear wheel to the transmission gear wheel.

16. The assembly according to claim 15, wherein the drive gear wheel and transmission gear wheel have a ratio other than 1:1.

17. The assembly according to claim 13, further comprising an encoder unit configured to detect a position of the motor shaft.

18. The assembly according to claim 17, further comprising a transmission shaft position sensor configured to detect a position of the transmission shaft.

19. A sewing machine comprising:
(a) a housing with an attachment region,
(b) a transmission with a transmission shaft carrying a transmission gear wheel, and a transmission shaft position sensor for sensing a position of the transmission shaft,
(c) a drive motor attachment comprised of: (i) a drive motor with a motor shaft carrying a drive gear wheel, and (ii) a motor shaft position sensor for sensing a position of the motor shaft, the drive motor attachment mounted to the attachment region of the sewing machine housing offsetting the motor shaft from the transmission shaft such that the motor shaft is not aligned with the transmission shaft; and
a flexible transmission member coupling the driver gear wheel to the transmission gear wheel transmitting motive force from the motor shaft to the transmission to power the sewing machine.

20. The sewing machine according to claim 19, wherein the flexible transmission member comprises a toothed belt.
